(19) United States
(12) Patent Application Publication
(10) Pub. No.: US 2020/0276665 A1
(43) Pub. Date: Sep. 3, 2020

(54) SPOT WELDING METHOD

(71) Applicant: NIPPON STEEL CORPORATION, Tokyo (JP)

(72) Inventors: Gen MURAYAMA, Tokyo (JP); Tohru OKADA, Tokyo (JP)

(73) Assignee: NIPPON STEEL CORPORATION, Tokyo (JP)

(21) Appl. No.: 16/646,942

(22) PCT Filed: Nov. 15, 2018
(86) PCT No.: PCT/JP2018/042366

§ 371 Date: Mar. 12, 2020

(30) Foreign Application Priority Data
Nov. 15, 2017 (JP) 2017-219693

(51) Int. Cl. B23K 11/00; B23K 11/11; B23K 11/16; B23K 11/36; B23K 37/04

(52) U.S. Cl. CPC B23K 11/0033; B23K 11/115; B23K 37/0435; B23K 11/36; B23K 11/16

(57) ABSTRACT

A spot welding method wherein even in a sheet combination with a sheet thickness ratio of 5 or more where the metal sheet with the thinnest sheet thickness is arranged at the outermost surface, it is possible to use an easily electrically controlled, compact welding apparatus to perform spot welding forming a desired nugget diameter while suppressing spatter at the interface of the thin sheet/thick sheet is provided. A spot welding method comprising preparing a sheet combination with a sheet thickness ratio of 5 or more having a metal sheet having a thinnest sheet thickness arranged at an outermost surface, arranging a first electrode tip at the side where the thinnest metal sheet is placed, arranging a second electrode tip at the opposite side of the sheet combination, and arranging an insulating first pressure application member around the first electrode tip, and pressing the first and second electrode tips and the first pressure application member against the sheet combination to apply electrode force so that an electrode force applied from the first electrode tip to the sheet combination becomes smaller than the second electrode tip while running current between the first and second electrode tips to weld the sheet combination.

### FIELD

The present disclosure relates to a spot welding method for resistance spot welding a sheet combination including a plurality of overlaid metal sheets.

### BACKGROUND

In assembly of the bodies of automobiles and attachment of parts etc., when joining an overlaid plurality of metal sheets with each other, mainly resistance spot welding has been used. In this spot welding, a pair of electrode tips with front end parts pressed against the sheet combination are being used.

In spot welding, electrode tips are pressed from the two sides of the overlaid plurality of metal sheets to clamp the metal sheets between them while running a current so as to form molten metal. After finishing running current, the electrode tips take back the heat or heat is conducted to the metal sheets themselves whereby the molten metal is cooled and made to solidify and a part formed by melting and solidification with an elliptical cross-sectional shape (nugget) is formed between the metal sheets.

In automobile bodies, in recent years, reduction of weight has been pursued. Portions which are difficult to weld have therefore appeared. As typical examples, there are three-layer spot welding parts of thin sheet/thick sheet/thick sheet configurations resulting from reduction of thickness of outer panels near the doors, called “side members”, and the increase of thickness of reinforcements of frame members called “B-pillars”. In this application, in an overlaid plurality of metal sheets, the metal sheet with the thinnest thickness will be referred to as a “thin sheet” and metal sheets thicker in thickness than this will be referred to as a “thick sheet”.

### CITATION LIST

### Patent Literature

[PTL 1] Japanese Unexamined Patent Publication No. 2011-11259
[PTL 2] Japanese Unexamined Patent Publication No. 2012-66284
[PTL 3] Japanese Unexamined Patent Publication No. 2006-55898

### SUMMARY

### Technical Problem

In spot welding of three layers of a thin sheet/thick sheet/thick sheet seen in automobile bodies etc., the metal sheet with the thinnest thickness is easy to work, so is generally placed at the outermost side of the assembly. In this case, the interface of the thick sheet/thick sheet is easy to melt, but the interface of the thin sheet/thick sheet is difficult to melt so stable spot welding is difficult.

In spot welding, melting is started from the center part of the sheet combination, which is the furthest away from the water cooled electrodes, so the thin sheet/thick sheet interface is difficult to melt. Furthermore, for the thin sheet, generally mild steel is used, while for the thick sheets, generally high tensile strength steel is used, so if using a sheet combination of such a combination, the contact area of the thin sheet and electrode tip becomes larger and the contact area of the thick sheet and the electrode tip becomes smaller, so the current density of the thin sheet side becomes smaller and the thin sheet/thick sheet interface becomes further difficult to melt. Furthermore, mild steel has a higher electrical conductivity than high tensile strength steel, so generation of heat is more difficult and the thin sheet/thick sheet interface becomes difficult to melt.

For this reason, in general, the upper limit of the sheet thickness ratio has been prescribed as 4 to 5 or so. This has become one factor obstructing the freedom of design.

To spot weld a sheet combination of a thin sheet/thick sheet with such a large sheet thickness ratio, the art of providing welding electrodes with pressure application members for applying pressure to the electrode tips and metal sheets (PTLs 1 and 2) and the art of applying pressure by two stages of pressure force and running current by two stages of current value (PTL 3) have been proposed.

However, in PTLs 1 and 2, to provide a difference in contact diameter to the interface of the thin sheet/thick sheet and interface of the thick sheet/thick sheet, it is necessary to provide predetermined distances between the electrode tips and pressure application rods. The apparatus becomes larger in the width direction of the sheet combination and it is difficult to spot weld a narrow location, for example, a flange of a width of 10 to 20 mm. Further, the polarity of the current differs between the electrode tips and pressure application rods, so electrical control for running current also becomes complicated. In PTL 3 as well, it is necessary to change the pressure forces and the current values during welding, the spot welding method becomes complicated, and the configuration of the spot welding apparatus also becomes complicated.

Therefore, even in a sheet combination with a sheet thickness ratio of 5 or more where the metal sheet with the thinnest sheet thickness is arranged at the outermost surface, a spot welding method able to use an easily electrically controlled, compact welding apparatus to perform spot welding forming a desired nugget diameter while suppressing spatter at the interface of the thin sheet/thick sheet is desirable.

### Solution to Problem

The gist of the present disclosure is as follows:

(1) A spot welding method for resistance spot welding a sheet combination comprised of a plurality of metal sheets with a sheet thickness ratio of 5 or more which are overlaid, the spot welding method comprising

preparing a sheet combination with a sheet thickness ratio of 5 or more having a metal sheet having a thinnest sheet thickness arranged at an outermost surface,

arranging a first electrode tip and a second electrode tip facing each other across the sheet combination so that the first electrode tip is arranged at the side where the thinnest metal sheet is placed and so that the second electrode tip is arranged at the opposite side of the sheet combination,

arranging a first pressure application member made of an insulator around the first electrode tip,

pressing front end parts of the first electrode tip and the first pressure application member and a front end part of the second electrode tip against the sheet combination to apply electrode forces so that an electrode force applied from the first electrode tip to the sheet combination becomes smaller than an electrode force applied from the second electrode tip to the sheet combination, and

running current between the first electrode tip and the second electrode tip while pressing the front end parts of the first electrode tip and the first pressure application member and the front end part of the second electrode tip against the sheet combination to apply electrode forces to thereby weld the sheet combination.

(2) The spot welding method according to (1), further comprising

arranging a second pressure application member made of a conductor around the second electrode tip,

pressing the front end parts of the first electrode tip and the first pressure application member and the front end part of the second electrode tip against the sheet combination to apply electrode forces and making the front end part of the second pressure application member contact with the sheet combination or press against the sheet combination to apply an electrode force so that an electrode force applied from the first electrode tip to the sheet combination becomes smaller than an electrode force applied from the second electrode tip to the sheet combination, and

running current between the first electrode tip and, the second electrode tip and the second pressure application member while pressing the front end parts of the first electrode tip and the first pressure application member and the front end part of the second electrode tip against the sheet combination to apply electrode forces and making the front end part of the second pressure application member contact with the sheet combination or press against the sheet combination to apply an electrode force to thereby weld the sheet combination.

(3) The spot welding method according to (1) or (2), wherein a mean distance between a body part of the first electrode tip and the first pressure application member is 0.5 mm or less.

(4) The spot welding method according to (2), wherein a mean distance between a body part of the second electrode tip and the second pressure application member is 0.5 mm or less.

(5) The spot welding method according to (2) or (4), wherein

when making the first electrode tip and the second electrode tip contact the sheet combination with an electrode force of zero, if

(inter-electrode distance of first electrode tip and second electrode tip)≤(total thickness of metal sheets forming sheet combination×1.1)

stands, an electrode force of the second pressure application member is lowered to 0.43 kN or less.

### Advantageous Effects of Invention

According to the spot welding method of the present disclosure, even in a sheet combination with a sheet thickness ratio of 5 or more where the metal sheet with the thinnest sheet thickness is arranged at the outermost surface, it is possible to use an easily electrically controlled, compact welding apparatus to perform spot welding forming a desired nugget diameter at the interface of the thin sheet/thick sheet while suppressing spatter.

### BRIEF DESCRIPTION OF DRAWINGS

FIG. 1 is a cross-sectional schematic view showing one example of a welding apparatus able to be used for the spot welding method of the present disclosure.

FIG. 2 is a cross-sectional schematic view showing one example of a welding apparatus able to be used for the spot welding method of the present disclosure.

FIG. 3 is a cross-sectional schematic view showing a state when pressing front end parts of pressure application members against a sheet combination and arranging front end parts of electrode tips at positions separated from the sheet combination.

FIG. 4 is a cross-sectional schematic view showing a state when pressing front end parts of electrode tips and front end parts of pressure application members against a sheet combination.

FIG. 5 is a cross-sectional schematic view showing a flow of current when running current between a first electrode tip and a second electrode tip.

FIG. 6 is a cross-sectional schematic view showing a flow of current when running current between a first electrode tip and a second electrode tip and second pressure application member.

FIG. 7 is a schematic view for explaining a method of measurement of nugget diameter.

FIG. 8 is a cross-sectional schematic view showing an example of a welding apparatus of the present disclosure when using a pneumatic cylinder as a second drive device.

FIG. 9 is a cross-sectional schematic view when making a pressure application member of the welding apparatus of FIG. 8 move.

FIG. 10 gives cross-sectional photos of sheet assemblies spot welded in examples.

FIG. 11 is a perspective view schematically showing a spot welded flange.

FIG. 12 is a cross-sectional schematic view showing an example when using a first electrode tip and a second electrode tip and a first pressure application member and a second pressure application member to apply pressure to the sheet combination.

FIG. 13 is a cross-sectional schematic view showing a state of pseudo formation of a state of provision of a sheet clearance between a thick sheet/thick sheet by placing spacers at the two facing end parts of the thick sheet/thick sheet.

FIG. 14 shows a graph showing the relationships of mean distances of electrodes and pressure application members and suitable current ranges in Examples 4 to 9 and Comparative Examples 3 to 4.

FIG. 15 shows a graph showing the relationships of mean distances of electrodes and pressure application members and suitable current ranges in Examples 2 and 10 to 14 and Comparative Examples 5 to 10.

### DESCRIPTION OF EMBODIMENTS

The present disclosure covers a spot welding method for resistance spot welding a sheet combination comprised of a plurality of metal sheets with a sheet thickness ratio of 5 or more which are overlaid, the spot welding method comprising preparing a sheet combination with a sheet thickness ratio of 5 or more having a metal sheet having a thinnest sheet thickness arranged at an outermost surface, arranging a first electrode tip and a second electrode tip facing each other across the sheet combination so that the first electrode tip is arranged at the side where the thinnest metal sheet is placed and so that the second electrode tip is arranged at the opposite side of the sheet combination, arranging a first pressure application member made of an insulator around the first electrode tip, pressing front end parts of the first electrode tip and the first pressure application member and a front end part of the second electrode tip against the sheet combination to apply electrode forces (pressures) so that an electrode force applied from the first electrode tip to the sheet combination becomes smaller than an electrode force applied from the second electrode tip to the sheet combination, and running current between the first electrode tip and the second electrode tip while pressing the front end parts of the first electrode tip and the first pressure application member and the front end part of the second electrode tip against the sheet combination to apply electrode forces to thereby weld the sheet combination.

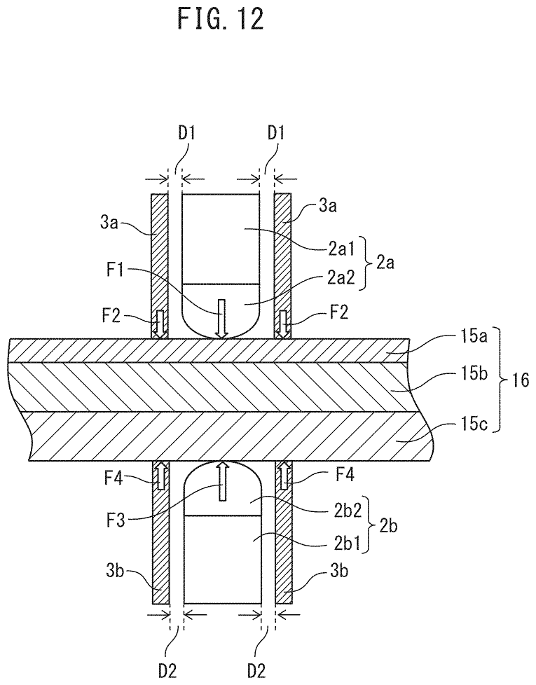

FIG. 12 is a cross-sectional schematic view showing an example when using the first electrode tip and the second electrode tip and the first pressure application member and the second pressure application member to apply pressures to the sheet combination.

As shown in FIG. 12, an electrode force applied from the first electrode tip 2a to the sheet combination 16 is designated as F1, an electrode force applied from the first pressure application member 3a to the sheet combination 16 is designated as F2, an electrode force applied from the second electrode tip 2b to the sheet combination 16 is designated as F3, and an electrode force applied from the second pressure application member 3b to the sheet combination 16 is designated as F4.

According to the spot welding method of the present disclosure, the electrode force F1 of the electrode tip at the thin sheet side can be made smaller than the electrode force F3 of the electrode tip at the thick sheet side and the current value of the electrode tip at the thin sheet side can be made larger than that of the prior art, so even when spot welding a sheet combination with a sheet thickness ratio of 5 or more, it is possible to suppress spatter and secure a broad suitable current range for forming the desired nugget diameter.

For example, it is possible to make the electrode force F1 of the electrode tip of the thin sheet 15a side 2.5 kN, make the electrode force F2 of the pressure application member made of the insulator around it 1.5 kN, and make the electrode force F3 of the electrode tip of the thick sheet 15c side 4.0 kN. By using the pressure application member around the electrode tip of the thin sheet side to make the electrode force F1 of the electrode tip of the thin sheet side smaller and make the electrode force F3 of the electrode tip of the thick sheet side larger in this way, it is possible to make deformation of the thin sheet smaller and reduce the contact area with the electrode and narrow the current carrying diameter, so the current density of the thin sheet side becomes larger and heat is generated more easily.

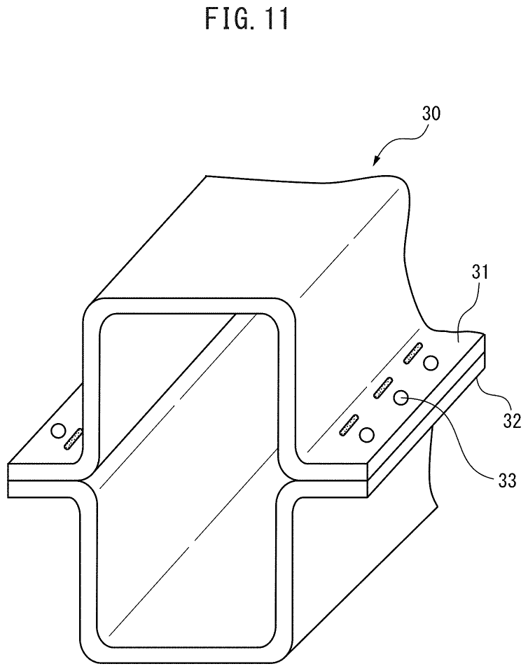

According to the method of the present disclosure, further, the electrode tips and the pressure application members can be arranged in proximity to each other, so the apparatus for performing the method of the present disclosure becomes compact and it is possible to easily spot weld even a narrow location, for example, a flange of a width of 10 to 20 mm or so such as shown in FIG. 11. Furthermore, by arranging the electrode tips and pressure application members in proximity to each other, it is possible to increase the suitable current range more. FIG. 11 is a perspective view schematically showing a spot welded flange. Further, it is possible to make the current value constant and make the direction of running the current constant, so control of the polarity of the current and switching the current over several stages also become unnecessary. Furthermore, there is no need to change the electrode force to the sheet combination during the spot welding. It can be performed with a constant pressure application.

According to the method of the present disclosure, further, if just changing the electrode tips and pressure application members, a conventional welding apparatus can be used.

The “suitable current range” means the range of current value from the minimum current value where a nugget of a reference diameter is formed to the maximum current value where a nugget of a reference diameter or more is formed without spatter. The suitable current range depends on the presence of any of the later explained sheet clearance and its size, but is preferably 1.5 kA or more, more preferably 1.8 kA or more, still more preferably 1.9 kA or more. The “reference diameter” is equal to 4√t (“t” is the thickness of the thinnest metal sheet). The reference diameter also means the reference nugget diameter. Note that, as explained later, the suitable current range becomes narrower if there is a sheet clearance or the sheet clearance becomes large.

In the spot welding method of the present disclosure, as shown in FIG. 12, as the welded member, a sheet combination with a sheet thickness ratio of 5 or more is prepared so that the metal sheet 15a with the thinnest sheet thickness is arranged at the outermost surface. The “sheet thickness ratio” is the value of the total thickness of the metal sheets forming the sheet combination divided by the thickness of the thinnest metal sheet and is expressed by the following formula:

Sheet thickness ratio=(Total thickness of metal sheets forming sheet combination)/(thickness of thinnest metal sheet)

The plurality of metal sheets includes two or more metal sheets. They can also be made three or more metal sheets according to the type of the structural part to be joined.

The spot welding method of the present disclosure can be particularly suitably used for welding three metal sheets overlaid so that the metal sheet with the thinnest thickness is arranged at an outermost surface.

The metal sheets are not particularly limited. They may be steel sheets of various chemical compositions. Further, the sheets may be aluminum, stainless steel, and other metal members other than steel sheets.

Preferably, the metal sheet with the thinnest thickness (thin sheet) is 270 MPa or less mild steel, while the other metal sheets (thick sheets) are 590 MPa or more, 980 MPa or more, 1180 MPa or more, or 1480 MPa or more high tensile strength steel. The method of the present disclosure can be suitably used for spot welding of a sheet combination of the above combination. For example, according to the method of the present disclosure, even when spot welding a sheet combination comprised of a 0.75 mm thick 270 MPa hot dip galvannealed steel sheet, a 1.6 mm thick 590 MPa hot dip galvannealed steel sheet, and a 2.3 mm thick 590 MPa hot dip galvannealed steel sheet with a sheet thickness ratio of 6.2, it is possible to suppress spatter while securing a broad suitable current range forming a desired nugget diameter.

Regardless of the presence of any second pressure application member, so long as the sheet thickness ratio is 5 or more, the thicknesses of the metal sheets are not particularly limited. For example, they may be 0.5 to 3.2 mm or 0.7 to 2.8 mm. Preferably, the thickness of the metal sheet with the thinnest thickness is 0.7 to 1.0 mm or 0.7 to 0.9 mm, while the thicknesses of the other metal sheets are 1.6 to 2.3 mm or 1.8 to 2.2 mm. The thickness of the sheet combination including the plurality of metal sheets (thickness of sheet combination as a whole) is also not particularly limited. For example, it may be 1.0 to 7.0 mm, 2.0 to 6.0 mm, or 2.4 to 5.0 mm.

According to the spot welding method of the present disclosure, regardless of the presence of any second pressure application member, it is possible to spot weld a sheet combination with a sheet thickness ratio of 5 or more, preferably 6 or more, more preferably 7 or more. The upper limit of the sheet thickness ratio does not have to be particularly determined, but the upper limit of the sheet thickness ratio may for example be made 20, 15, or 10. According to the spot welding method of the present disclosure, by reducing the electrode force F1 of the electrode tip on the thin sheet side and increasing the electrode force F3 of the electrode tip on the thick sheet side, it is possible to raise the current density of the thin sheet side, so it is possible to shift the position of the nugget diameter to the thin sheet side and possible to spot weld a sheet combination having a large sheet thickness ratio of the above range.

The metal sheets may be ones with both surfaces or single surfaces formed with platings or other surface treatment coating films or may be ones not formed with surface treatment coating films. The metal sheets need only be ones having sheet shaped parts at least in part and having parts where the sheet shaped parts are overlaid with each other. They need not be sheet shaped as a whole. For example, they may also be shaped steels. The plurality of metal sheets are not limited to ones comprised of separate metal sheets. They may also be obtained by forming a single metal sheet into a tube or other predetermined shape, then collapsing it.

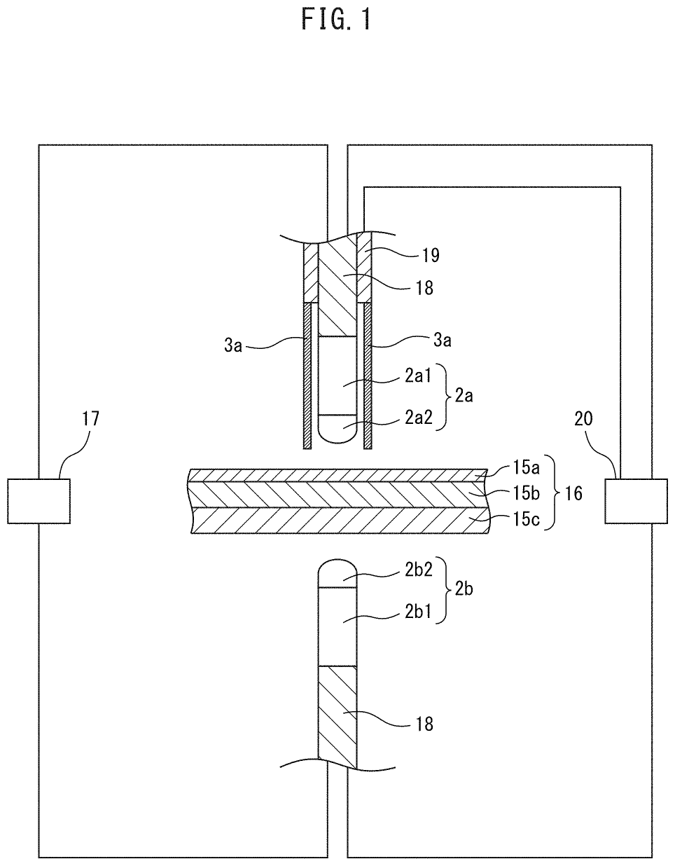

As illustrated in FIG. 12 or FIG. 1, the first electrode tip 2a and the second electrode tip 2b are arranged facing each other so that the former is arranged at the side where the thinnest metal sheet 15a is placed and the latter is arranged at the opposite side of the sheet combination. In other words, the first electrode tip and the second electrode tip are arranged facing each other so as to clamp between them a sheet combination comprised of a plurality of superposed metal sheets with a sheet thickness ratio of 5 or more.

As illustrated in FIG. 12 or FIG. 1, the first electrode tip 2a and the second electrode tip 2b can be driven in the axial direction of the electrode tips and made to stop at any positions. A front end part 2a2 of the first electrode tip 2a and a front end part 2b2 of the second electrode tip 2b can be pressed against the sheet combination to clamp the sheet combination between them. The electrode tips can be moved relative to the pressure application members.

Current can be run through the first electrode tip and the second electrode tip by a predetermined current value and number of cycles. The current run through the sheet combination by the electrode tips can be changed in accordance with the strengths and thicknesses of the metal sheets included in the sheet combination. For example, it is possible run a current of 4 to 15 kA for a time of 5 to 50 cycles (power supply frequency 50 Hz).

The electrode tips are not particularly limited. Known ones may be used, but preferably they are made of Cu, Cu—Cr alloy, or alumina dispersion-strengthened Cu. The electrode tips preferably have body parts having 2 to 16 mm cylindrical shapes and front end parts having front end shapes of a DR type (dome radius type) with a front end diameter of 6 to 8 mm, a CF type (conical flat shape), CR type (conical radius shape), DF type (dome flat shape), or D type. In the illustration of FIG. 12, the first electrode tip 2a has a body part 2a1 and a front end part 2a2, while the second electrode tip 2b has a body part 2b1 and a front end part 2b2. The electrode tips preferably are shaped with circular cross-sections in directions vertical to the directions of pressure application.

As illustrated in FIG. 12 or FIG. 1, the first pressure application member 3a made of an insulator is arranged around the first electrode tip 2a. The first pressure application member can be driven in the axial direction of the electrode tip and made to stop at any position. The front end part of the first pressure application member can be pressed against the sheet combination to apply the electrode force F2. The material of the first pressure application member made of an insulator is not particularly limited so long as having heat resistance and having predetermined mechanical properties enabling pressure to be applied to the sheet combination, but preferably is a resin, more preferably an engineering plastic, still more preferably an aromatic resin polyether ketone resin (PEEK) or a polyamide resin.

The shape of the first pressure application member is preferably a point symmetric cylindrical shape centered about the first electrode tip, a partial cylindrical shape with part of the cylindrical shape cut away, but the major part having a point symmetric cylindrical shape centered around the first electrode tip, or a regular polygonal tubular shape having five or more faces point symmetric or line symmetric centered around the first electrode tip, more preferably the above cylindrical shape or partial cylindrical shape, still more preferably the above cylindrical shape. By having the above shape, the first pressure application member can be arranged around the first electrode tip and can apply pressure to the sheet combination point symmetrically or line symmetrically centered about the first electrode tip to uniformly lighten the electrode force of the first electrode tip. The region of application of pressure at the first pressure application portion may also be shaped to become 40% or more, 50% or more, or 75% or more of the surroundings of the first electrode tip. Further, if necessary, this region may be shaped to become the entire circumference of the first electrode tip, that is, 100%.

The first pressure application member is preferably constant in inside diameter in the direction of pressure application. Due to this, it is possible to make the electrode tip and pressure application member move relative to each other separately without interfering with each other. To make them move in this way, the first pressure application member is preferably made a cylindrical shape. More preferably, the distance (interval) from outer circumference of the surface of the first electrode tip abutting against the metal sheet to the inside diameter of the first pressure application member is over 5 mm or over 6 mm.

The inside diameter of the first pressure application member is preferably close to the diameter of the first electrode tip in the range of possible movement. The mean distance between the body part of the first electrode tip 2a and the first pressure application member is preferably 0.5 mm or less, more preferably 0.3 mm or less, still more preferably 0.2 mm or less, even more preferably 0.1 mm or less. The mean distance between the body part of the first electrode tip and the first pressure application member is the mean distance D1 in the direction vertical to the direction of pressure application between the outside diameter of the body part 2a1 of the first electrode tip 2a and the inside diameter of the first pressure application member 3a shown in FIG. 12. By the mean distance of the body part of the first electrode tip and the first pressure application member being within the above range, the suitable current range can also be made larger. The first pressure application member made of an insulator may contact the first electrode tip or not contact it.

The thickness of the first pressure application member 3a in the direction vertical to the direction of pressure application can, for example, be made 1 to 7 mm or 1 to 5 mm. The first pressure application member may be a cylindrical member having an upper limit of the outside diameter of 30 mm, 25 mm, or 20 mm and having a lower limit of the outside diameter of 10 mm or 15 mm. The lower limit of the outside diameter of the first pressure application member is the outside diameter of the first electrode tip.

The front end parts of the first electrode tip and the first pressure application member and the front end part of the second electrode tip are pressed against the sheet combination to apply electrode forces so that the electrode force F1 applied from the first electrode tip to the sheet combination becomes smaller than the electrode force F3 applied from the second electrode tip to the sheet combination.

The total of the electrode forces F1 and F2 applied from the first electrode tip and the first pressure application member to the sheet combination and the electrode force F3 applied from the second electrode tip to the sheet combination are equal, so if the electrode force F2 is applied from the first pressure application member to the sheet combination, the electrode force F1 applied from the first electrode tip to the sheet combination can be reduced by that amount. Due to this, the electrode force F1 applied from the first electrode tip to the sheet combination can be made smaller than the electrode force F3 applied from the second electrode tip to the sheet combination.

Preferably, the ratio of the electrode force F1 applied from the first electrode tip to the sheet combination:the electrode force F3 applied from the second electrode tip to the sheet combination is (10 to 95):100. That is, regardless of the presence of any second pressure application member, the electrode force F1 is preferably 10 to 95% of the electrode force F3. The upper limit of the ratio of the electrode force F1 to the electrode force F3 may be made 90%, 85%, 80%, or 70%. The lower limit of the ratio of the electrode force F1 to the electrode force F3 may be made 20%, 30%, or 40%. More preferably, the electrode force F1 applied from the first electrode tip to the sheet combination is 1.5 to 2.5 kN smaller than the electrode force F3 applied from the second electrode tip to the sheet combination. The electrode force F2 is applied from the first pressure application member to the sheet combination by the amount of the electrode force F1 applied from the first electrode tip to the sheet combination smaller than the electrode force F3 applied from the second electrode tip to the sheet combination so the electrode forces applied clamping the sheet combination are balanced.

The electrode force F2 applied from the first pressure application member to the sheet combination can be changed in accordance with the strengths and thicknesses of the metal sheets included in the sheet combination. For example, it may be 0.0 to 6.0 kN or 1.5 to 4.5 kN.

The electrode force F3 applied from the second electrode tip to the sheet combination can be changed in accordance with the strengths and thicknesses of the metal sheets included in the sheet combination. For example, it may be 0.0 to 6.0 kN or 1.5 to 4.5 kN.

The spot welding method of the present disclosure preferably comprises arranging a second pressure application member made of a conductor around the second electrode tip, pressing the front end parts of the first electrode tip and the first pressure application member and the front end part of the second electrode tip against the sheet combination to apply electrode forces F1, F2, and F3 and make the front end part of the second pressure application member contact or press against the sheet combination to apply the electrode force F4 so that the electrode force F1 applied from the first electrode tip to the sheet combination becomes smaller than the electrode force F3 applied from the second electrode tip to the sheet combination, and running current between the first electrode tip, and the second electrode tip and the second pressure application member while pressing the front end parts of the first electrode tip and the first pressure application member and the front end part of the second electrode tip against the sheet combination to apply electrode forces F1, F2, and F3 and make the front end part of the second pressure application member contact or press against the sheet combination to apply the electrode force F4 to thereby weld the sheet combination.

As illustrated in FIG. 12 or FIG. 1, by using the pressure application member 3a made of an insulator at the thin sheet 15a side and the pressure application member 3b made of a conductor at the thick sheet 15c side, it is possible to reduce the electrode force F1 of the electrode tip 2a contacting the thin sheet 15a and increase the electrode force F3 of the electrode tip 2b contacting the thick sheet 15c and narrow the current-carrying diameter running current from the electrode tip 2a contacting the thin sheet 15a to the thin sheet 15a and broaden the current-carrying diameter running current to the thick sheet 15c, so it is possible to increase the current density at the thin sheet 15a side more.

For example, it is possible to make the electrode force F1 of the electrode tip 2a at the thin sheet 15a side 2.5 kN and make the electrode force F2 of the surrounding pressure application member 3a made of an insulator 1.5 kN and to make the electrode force F3 of the electrode tip 2b at the thick sheet 15c side 3.9 kN and make the electrode force F4 of the surrounding pressure application member 3b 0.1 kN.

As illustrated in FIG. 12, even if pressing the front end part of the second pressure application member to apply the electrode force F4, the front end parts of the first electrode tip and the first pressure application member and the front end parts of the second electrode tip and the second pressure application member are pressed against the sheet combination to apply electrode forces so that the electrode force F1 applied from the first electrode tip to the sheet combination becomes smaller than the electrode force F3 applied from the second electrode tip to the sheet combination.

The front end part of the second pressure application member can be made to contact the sheet combination with substantially zero electrode force or to press against it to apply the electrode force F4 while electrically heating the sheet combination from the second pressure application member as well. By electrically heating the sheet combination from the second pressure application member as well in addition to the second electrode tip, even when spot welding a sheet combination comprised of a plurality of metal sheets with a sheet thickness ratio of 5 or more which are overlaid, it is possible to more stably form the desired nugget diameter without causing spatter. By using a pressure application member made of a conductor at the thick sheet side, it is possible to lower the current density at the thick sheet side, possible to shift the position of the nugget diameter to the thin sheet side, and possible to spot weld a sheet combination having a large sheet thickness ratio of a sheet thickness ratio of 5 or more, preferably 6 or more, more preferably 7 or more.

The current carried to the sheet combination by the second pressure application member can be changed in accordance with the strengths and thicknesses of the metal sheets contained in the sheet combination. For example, 4 to 15 kA current can be run for a time of 5 to 50 cycles (power supply frequency 50 Hz).

The material of the second pressure application member made of a conductor is not particularly limited so long as having heat resistance and having predetermined mechanical properties enabling contact with the sheet combination or application of pressure to the sheet combination, but preferably is a Cu, Cu—Cr alloy or alumina dispersion-reinforced Cu. The second electrode tip and the second pressure application member may be different in material, but preferably are the same in material.

The second pressure application member can be driven in the axial direction of the electrode tip and made to stop at any position. The front end part of the second pressure application member can be pressed against the sheet combination to apply the electrode force F4.

The shape of the second pressure application member is preferably a point symmetric cylindrical shape centered about the second electrode tip, a partial cylindrical shape with part of the cylindrical shape cut away, but the major part having a point symmetric cylindrical shape centered around the second electrode tip, or a regular polygonal tubular shape having five or more faces point symmetric or line symmetric centered around the second electrode tip, more preferably the above cylindrical shape or partial cylindrical shape, still more preferably the above cylindrical shape. By having the above shape, the second pressure application member can be arranged around the second electrode tip and can contact the sheet combination or apply pressure to the sheet combination point symmetrically or line symmetrically centered about the second electrode tip to more uniformly broaden the current carrying diameter running current to the thick sheet 15c centered around the second electrode tip to thereby lower the current density of the thick sheet side. The shape may also be one where the region of application of pressure at the second pressure application portion becomes 40% or more, 50% or more, or 75% or more of the surroundings of the second electrode tip. Further, if necessary, the shape may be made one where this region becomes the entire circumference of the second electrode tip, that is, 100%.

The second pressure application member is preferably constant in inside diameter in the direction of pressure application. Due to this, it is possible to make the electrode tip and pressure application member move relative to each other separately without interfering with each other. To make them move in this way, the second pressure application member is preferably made a cylindrical shape. More preferably, the distance (interval) from outer circumference of the surface of the second electrode tip abutting against the metal sheet to the inside diameter of the second pressure application member is over 5 mm or over 6 mm.

The inside diameter of the second pressure application member is preferably close to the diameter of the second electrode tip in the range of possible movement. The mean distance between the body part of the second electrode tip and the second pressure application member is preferably 0.5 mm or less, more preferably 0.3 mm or less, still more preferably 0.2 mm or less, even more preferably 0.1 mm or less. The mean distance between the body part of the second electrode tip and the second pressure application member is the mean distance D2 in the direction vertical to the direction of pressure application between the outside diameter of the body part 2b1 of the second electrode tip and the inside diameter of the first pressure application member 3b shown in FIG. 12. By the mean distance of the body part of the second electrode tip and the second pressure application member being within the above range, the suitable current range can also be made larger.

The thickness of the second pressure application member 3b in the direction vertical to the direction of pressure application can, for example, be made 1 to 7 mm or 1 to 5 mm. The second pressure application member may be a cylindrical member having an upper limit of the outside diameter of 30 mm, 25 mm, or 20 mm and having a lower limit of the outside diameter of 10 mm or 15 mm. The lower limit of the outside diameter of the second pressure application member is the outside diameter of the second electrode tip.

The mean distance between the body part of the first electrode tip and the first pressure application member and the mean distance between the body part of the second electrode tip and the second pressure application member can be set respectively separately.

The electrode force F4 applied from the second pressure application member to the sheet combination can for example be 0.0 to 6.0 kN or 1.5 to 4.5 kN. The metal sheets forming the sheet combination sometimes warp or otherwise deform due to springback caused at the time of press forming etc. In this case, there is sometimes a clearance in the overlaid sheet combination (called “sheet clearance”). If the metal sheets deform, the thickness of the sheet combination becomes larger than the total thickness of the metal sheets forming the sheet combination by the amount of the clearance in the overlaid sheet combination. Compared to between a comparatively soft thin sheet and a thick sheet as well, a clearance is easily formed between one relatively hard thick sheet and another thick sheet. If the thickness of the sheet combination is larger than the total thickness of the metal sheets forming the sheet combination, there is a clearance in the overlaid sheet combination, but even when there is no clearance in the overlaid sheet combination or there is a clearance but it is small, even if making the electrode force F4 of the second pressure application member small, by applying the electrode force F1 of the first electrode tip, the electrode force F2 of the first pressure application member, and the electrode force F3 of the second electrode tip to the sheet combination, it is possible to make the metal sheets forming the sheet combination contact each other at the welded location. For this reason, when there is no clearance in the overlaid sheet combination or there is a clearance but it is small, it is preferable to make the electrode force F4 of the second pressure application member smaller within a range enabling prevention of spatter and make the application of pressure concentrate at the second electrode tip to enlarge the contact area between the second electrode tip and the thick sheet.

The case where there is no clearance in the sheet combination or there is clearance, but it is small indicates the state where when the first electrode tip and the second electrode tip are both made to contact the sheet combination with substantially zero electrode force before welding, (inter-electrode distance between first electrode tip and second electrode tip)≤(total thickness of metal sheets forming sheet combination×1.1) stands.

When making the first electrode tip and the second electrode tip contact the sheet combination with a substantially zero electrode force, if (inter-electrode distance between first electrode tip and second electrode tip)(total thickness of metal sheets forming sheet combination×1.1) stands, the electrode force F4 of the second pressure application member is preferably lowered to 0.43 kN or less, more preferably 0.10 kN or less, still more preferably 0.00 kN. Further, the electrode force F4 of the second pressure application member may be made 40% or less, 30% or less, 20% or less, or 10% or less of the total of the electrode force F3 of the second electrode tip and the electrode force F4 of the second pressure application member.

On the other hand, if there is a large clearance in the overlaid sheet combination, the electrode force F4 applied from the second pressure application member to the sheet combination is preferably made over 0.43 kN. If there is a large clearance in the sheet combination, the inter-electrode distance between the first electrode tip and the second electrode tip when making the first electrode tip and the second electrode tip contact the sheet combination with a substantially zero electrode force before welding is over 1.1 times of the total thickness of the metal sheets forming the sheet combination, preferably 1.5 times or less, more preferably 1.4 times or less, still more preferably 1.3 times or less, even more preferably 1.2 times or less.

The second pressure application member made of a conductor may contact the second electrode tip or not contact it. The second electrode tip and the second pressure application member are connected to the power supply to which the first electrode tip is connected and divide the current to reduce the current at the electrode tip. The current is divided in accordance with the material and cross-sectional area of the second electrode tip and the second pressure application member.

Preferably, the front end parts of the first pressure application member and the second pressure application member are pressed against the sheet combination to apply the electrode forces F2 and F4, then the front end parts of the first electrode tip and the second electrode tip are pressed against the sheet combination to apply the electrode forces F1 and F3. Due to this, it is possible to reduce the tact time of the spot welding.

One example of the configuration of the spot welding apparatus able to be used for the method of the present disclosure will be explained with reference to the drawings.

FIG. 1 is a cross-sectional schematic view showing one example of the configuration of a spot welding apparatus when spot welding a sheet combination including a plurality of metal sheets.

The welding apparatus described in FIG. 1 is provided with the first electrode tip 2a and the second electrode tip 2b with front end parts to be pressed against the sheet combination 16 (below, also referred to as “the pair of electrode tips”), the first pressure application member 3a made of an insulator arranged around the first electrode tip 2a and with a front end part to be pressed against the sheet combination 16, a power supply 17 connected to the pair of electrode tips, a first drive mechanism 18 connected to the pair of electrode tips, a second drive mechanism 19 connected to the first pressure application member 3a, and an electrode force control part 20 connected to the first drive mechanism 18 and the second drive mechanism 19.

The power supply 17 can run a current through the electrode tips by a predetermined current value and cycles. The current run through the sheet combination by the electrode tips can be changed in accordance with the strengths and thicknesses of the metal sheets included in the sheet combination. For example, it is possible to run a current of 4 to 15 kA for a time of 5 to 50 cycles (power supply frequency 50 Hz).

The first drive mechanism 18 can drive the pair of electrode tips in the axial direction of the electrode tips and make them stop at any positions and can give electrode forces pressing the pair of electrode tips against the sheet combination 16. The second drive mechanism 19 can drive the first pressure application member 3a in the axial direction of the electrode tip and make it stop at any position and can give an electrode force pressing the first pressure application member 3a against the sheet combination 16.

The first drive mechanism and the second drive mechanism are independently preferably pneumatic cylinders, hydraulic cylinders, springs, ball screws, electric cylinders, actuators, gear drives, or rack and pinions, more preferably are pneumatic cylinders, hydraulic cylinders, or electric cylinders. They may be selected from the above drive mechanisms according to the actual installation environment etc.

Pneumatic cylinders do not contaminate other areas even if air leaks and are easy to maintain. Hydraulic cylinders are strong against heat and can give large power. Electric cylinders do not require piping and enable high precision control.

The electrode force control part 20 independently controls the electrode force applied by the first drive mechanism 18 and the electrode force applied by the second drive mechanism 19. The electrode force control part 20 controls these electrode forces so that the electrode force applied from the first electrode tip 2a and the first pressure application member 3a and the electrode force applied from the second electrode tip 2a become the same.

The first drive mechanism 18 connected to the pair of electrode tips may be configured by a pair of separate mechanisms or may be configured integrally.

The pair of electrode tips and the first pressure application member 3a clamp the sheet combination 16 including the plurality of metal sheets from the two sides. FIG. 1 illustrates the state of clamping the sheet combination 16 of the three metal sheets 15a, 15b, and 15c. The metal sheet 15a is the thinnest in thickness among the three metal sheets. The sheet thickness ratio of the sheet combination of the three metal sheets 15a, 15b, and 15c is 5 or more.

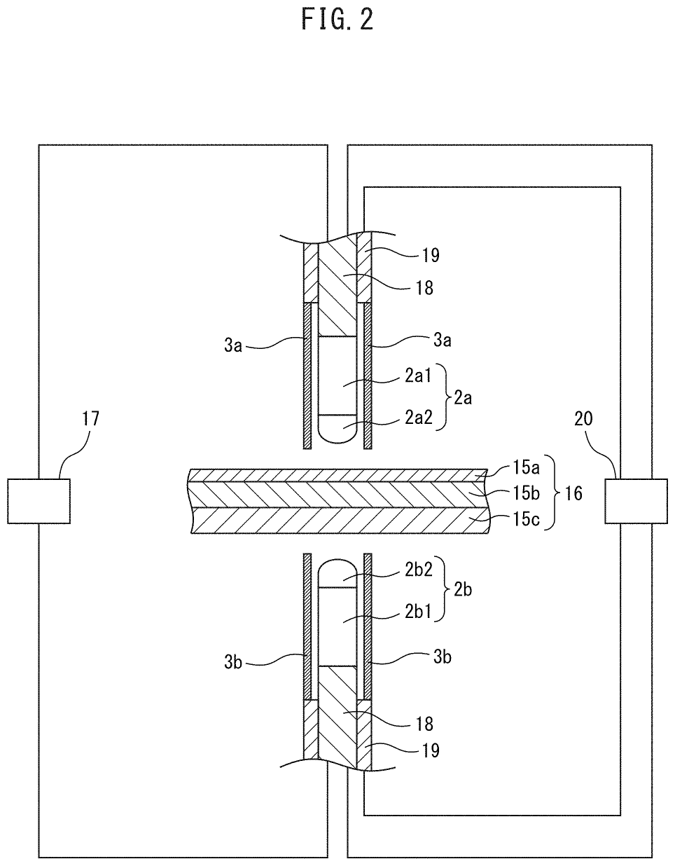

The welding apparatus described in FIG. 2 is provided with the first electrode tip 2a and the second electrode tip 2b with front end parts to be pressed against the sheet combination 16 (below, also referred to as “the pair of electrode tips”), the first pressure application member 3a made of an insulator arranged around the first electrode tip 2a and with a front end part to be pressed against the sheet combination 16, the second pressure application member 3b made of a conductor arranged around the second electrode tip 2b and with a front end part to be pressed against the sheet combination 16, the power supply 17 connected to the pair of electrode tips, the first drive mechanism 18 connected to the pair of electrode tips, the second drive mechanism 19 connected to the first pressure application member 3a and the second pressure application member 3b, and the electrode force control part 20 connected to the first drive mechanism 18 and the second drive mechanism 19.

The first drive mechanism 18 drives the pair of electrode tips in the axial directions of the electrode tips and makes them stop at any positions and applies electrode forces pressing the pair of electrode tips against the sheet combination 16. The second drive mechanism 19 drives the first pressure application member 3a and the second pressure application member 3b in the axial directions of the electrode tips and makes them stop at any positions and applies electrode forces pressing the first pressure application member 3a and the second pressure application member 3b against the sheet combination 16.

The electrode force control part 20 independently controls the electrode force given by the first drive mechanism 18 and the electrode force given by the second drive mechanism 19. The electrode force control part 20 controls the respective electrode forces so that the electrode forces applied from the first electrode tip 1a and the first pressure application member 3a and the electrode forces applied from the second electrode tip 2a and the second pressure application member 3b become the same.

The first drive mechanism 18 connected to the pair of electrode tips may be configured by a pair of separate mechanisms or may be configured by an integral mechanism.

The pair of electrode tips and the first pressure application member 3a and the second pressure application member 3b, in the same way as FIG. 1, clamp the sheet combination 16 including the plurality of metal sheets from the two sides.

When spot welding, the front end parts of the pair of electrode tips are pressed against the sheet combination 16. At this time, the front end parts of the electrode tips and the front end parts of the pressure application members may be pressed against the sheet combination 16 simultaneously or at different timings. Explaining this using FIG. 2 as an example, the front end parts of the pair of electrode tips and the front end parts of the first pressure application member 3a and the second pressure application member 3b (below, also referred to as the “pair of pressure application members”) may be simultaneously pressed against the sheet combination 16, the front end parts of the pair of pressure application members may be pressed against the sheet combination 16, then the front end parts of the pair of electrode tips may be pressed against the sheet combination 16, or the front end parts of the pair of electrode tips may be pressed against the sheet combination 16, then the front end parts of the pair of pressure application members may be pressed against the sheet combination 16.

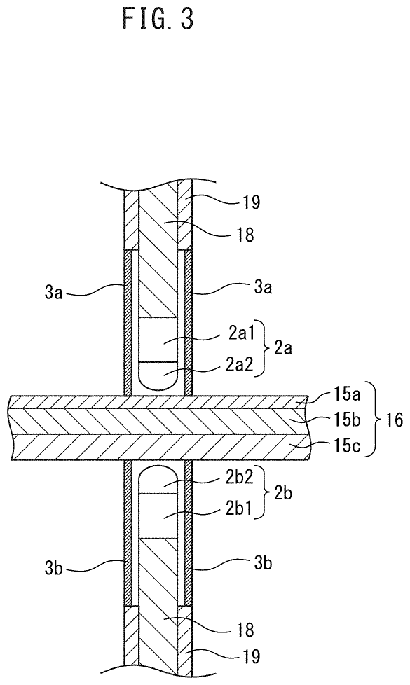

Preferably, as shown in FIG. 3, before spot welding, the front end parts of the pair of pressure application members are pressed against the sheet combination 16 and the front end parts of the pair of electrode tips are placed at positions separated from the sheet combination 16. FIG. 3 is a cross-sectional schematic view of the state of pressing the front end parts of the pair of pressure application members against the sheet combination 16 and placing the front end parts of the pair of electrode tips at positions separated from the sheet combination 16. When pressing the front end parts of the pair of pressure application members against the sheet combination 16 and placing the front end parts of the pair of electrode tips at positions separated from the sheet combination 16, the front end parts of the pair of electrode tips may also be placed at positions separated from the sheet combination by for example 0 to 5 mm or 1 to 3 mm.

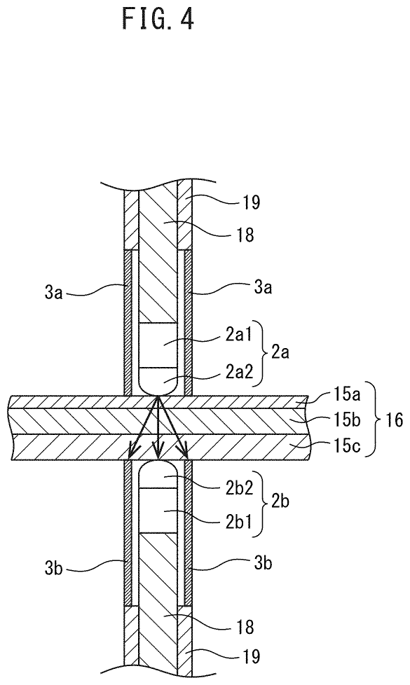

As shown in FIG. 3, after pressing the front end parts of the pair of pressure application members against the sheet combination 16 and placing the front end parts of the pair of electrode tips at positions separated from the sheet combination 16, next the pair of electrode tips can be made to move relative to the pair of pressure application members to, as shown in FIG. 4, make the pair of electrode tips contact the metal sheets 15. FIG. 4 is a cross-sectional schematic view showing the state when pressing the front end parts of the pair of electrode tips and the front end parts of the pair of pressure application members against the sheet combination 16.

In FIG. 3, before making the pair of electrode tips contact the sheet combination 16, the pair of pressure application members can be used to apply pressures to the sheet combination 16 by desired electrode forces, so in FIG. 4, it is possible to make the pair of electrode tips contact the sheet combination 16 and simultaneously run current and possible to shorten the tact time of spot welding. In FIG. 3 and FIG. 4 as well, the spot welding apparatus is provided with the power supply 17 and electrode force control part 20, but these are not shown.

As shown in FIG. 4 by the solid arrows, it is possible to run current between the first electrode tip 2a, and the second electrode tip 2b and second pressure application member 3b to form molten metal at the overlaid surfaces of the metal sheet 15a/metal sheet 15b/metal sheet 15c.

As shown in FIG. 4, it is possible to press the first electrode tip and the second electrode tip against the sheet combination 16 and further press the first pressure application member against the sheet combination 16 and make the second pressure application member contact or press against the sheet combination 16 and, in that state, run current between the first electrode tip 2a, and the second electrode tip 2b and the second pressure application member 3b to form molten metal at the overlaid surfaces of the metal sheet 15a/metal sheet 15b/metal sheet 15c. The electrode force is applied from the first pressure application member 3a so that the electrode force applied from the first electrode tip to the sheet combination becomes smaller than the electrode force applied from the second electrode tip to the sheet combination. Furthermore, current is run between the first electrode tip 2a and the second electrode tip 2b and second pressure application member 3b. So the current density at the interface of the metal sheet 15a/metal sheet 15b can be made larger. Even if spot welding a sheet combination with a sheet thickness ratio of 5 or more, spatter can be suppressed while broadly securing a suitable current range for forming a desired nugget diameter. The electrode force of the second pressure application member may be made larger or may be made zero in accordance with the strengths and thicknesses of the metal sheets included in the sheet combination within a range where the electrode force applied from the first electrode tip to the sheet combination becomes smaller than the electrode force applied from the second electrode tip to the sheet combination and a range where no spatter is caused.

After running the current, it is possible to remove heat by cooling the pair of electrode tips and conducting heat to the surroundings of the weld zone of the sheet combination 16 to thereby rapidly cool and make the molten metal solidify and form a nugget with an elliptical shaped cross-section at the metal sheet 15a/metal sheet 15b/metal sheet 15c. After forming the nugget, the electrode tips and pressure application members can be separated from the metal sheets and the welding apparatus can be returned to the state when standing by for welding.

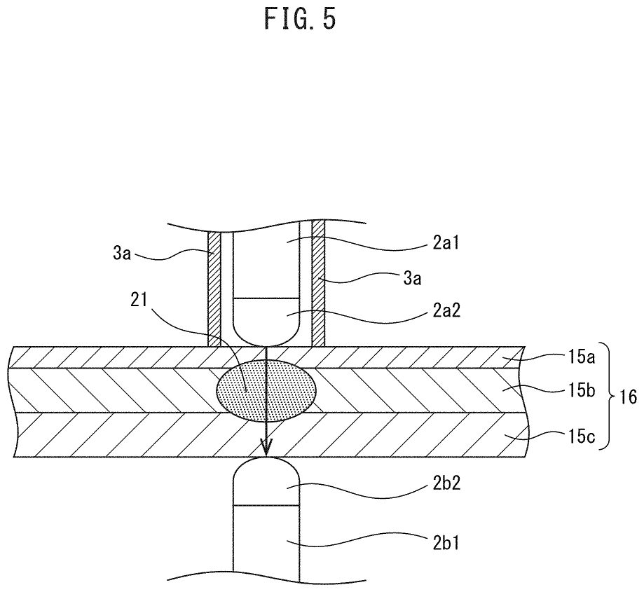

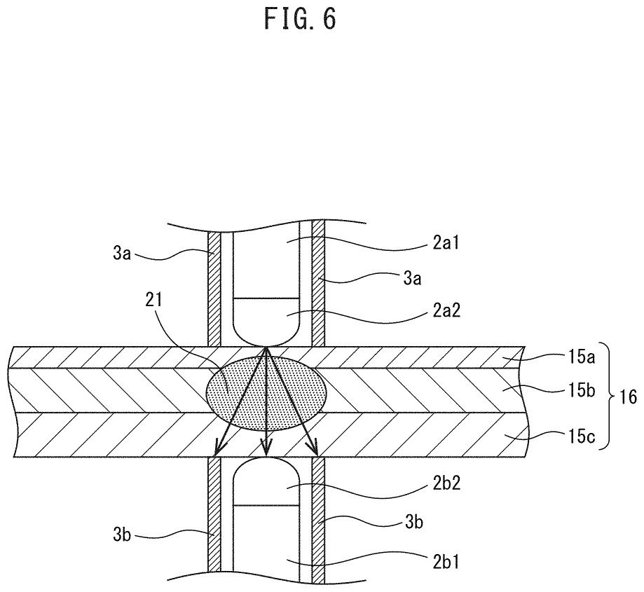

FIG. 5 is a cross-sectional schematic view showing the flow of current when running current between the first electrode tip and the second electrode tip, while FIG. 6 is a cross-sectional schematic view showing the flow of current when running current between the first electrode tip and the second electrode tip and second pressure application member.

In FIG. 5, as shown by the arrow, current flows only between the first electrode tip and the second electrode tip, but in FIG. 6, as shown by the arrows, the conductive second pressure application member is made to contact the sheet combination 16, so current can be run between the first electrode tip and the second electrode tip and second pressure application member. For this reason, at the interface of the thin sheet 15a/thick sheet 15b, it is possible to form a nugget more stably.

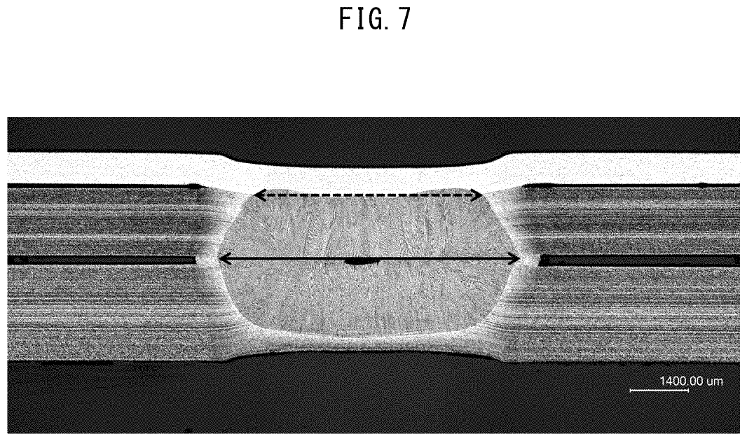

The method of confirmation of the nugget diameter was made as shown in FIG. 7. FIG. 7 is an enlarged photograph of the cross-section obtained by cutting a spot welded sheet combination through the center of the spot welded part, burying this in resin and polishing it, then etching this by metal flow etching. The nugget is the melted and solidified part of FIG. 7. The nugget diameter at the thin sheet and thick sheet interface is shown by the broken line arrow, while the nugget diameter at the thick sheet and thick sheet interface is shown by the solid line arrow.

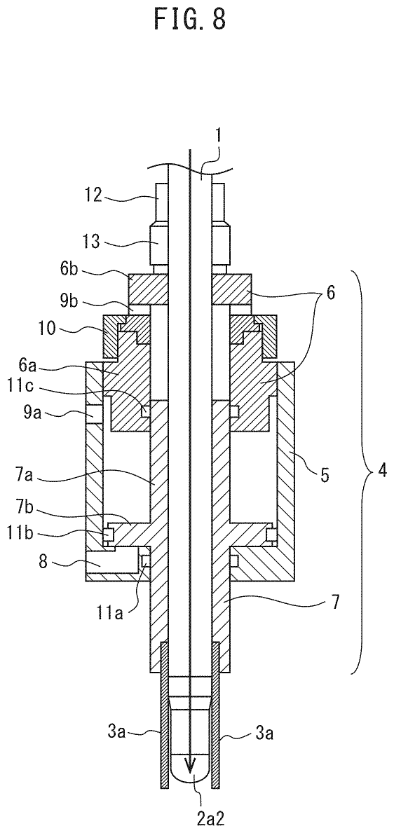

FIG. 8 is a cross-sectional schematic view of one example of a welding apparatus able to be used for the spot welding method of the present disclosure in the case of using a pneumatic cylinder as a second drive mechanism. The first drive mechanism is preferably a pneumatic cylinder, but may also be a hydraulic cylinder, electric cylinder, etc. In FIG. 8, the first drive mechanism is omitted, but if the first drive mechanism is a pneumatic cylinder, it may be configured in the same way as the pneumatic cylinder of the second drive mechanism illustrated in FIG. 8.

The first electrode tip 2a is attached to a rod-shaped shank 1. The shank 1 is assembled in a holder (not shown) attached to a spot welding gun. The first pressure application member 3a is arranged around the first electrode tip 2a. The power supply and electrode force control part are not shown.

Other than the pressure application members, the welding apparatus is provided with a pair of electrode tips. Two parts of the welding apparatus are used arranged facing each other across the overlaid plurality of metal sheets, but the basic configurations of the two facing each other are the same, so below one part of the welding apparatus will be explained. The case of not using the second pressure application member and the case of using one are substantially the same.

The shank 1 and the first electrode tip 2a can move relative to the pneumatic cylinder 4. The shank 1 is fastened to the pneumatic cylinder 4 by a Cu-1 mass % Cr screw adapter 12 and a nut 13.

The second drive mechanism comprised of the pneumatic cylinder 4 has a substantially cylindrically shaped cylinder housing 5 in which the shank 1 is inserted, a disk shaped rod cover 6 closing the cylinder housing 5, and a piston rod 7 moving inside the cylinder housing 5 in the axial direction of the shank 1. The piston rod 7 has a cylindrically shaped rod part 7a into which the shank 1 is inserted and a ring part 7b formed at the outer circumference of the rod part 7a and is formed by SUS304 etc.

The cylinder housing 5 has ports 8 and 9a for supplying and discharging air for moving the piston rod 7 at the side where the pressure application member 3 is attached to the piston rod 7 relative to the ring part 7b of the piston rod 7 (below, referred to as the “inside”) and the rod cover 6 side (below, referred to as the “outside”). The cylinder housing 5 is formed by SUS304 etc.

The rod cover 6 has a lower cover 6a restricting the range of movement of the piston rod 7 and an upper cover 6b having a port 9b supplying and discharging air at the outside of the rod part 7a of the piston rod 7 and is formed by SUS304 etc. The lower cover 6a and the upper cover 6b are fastened by bag nuts 10.

The cylinder housing 5, piston rod 7, and lower cover 6a are respectively provided with O-rings 11a, 11b, and 11c. By keeping down movement of compressed air between the inside and outside relative to the ring part 7b of the piston rod 7 and supplying and discharging compressed air through the port 8 and the ports 9a and 9b, it is possible to make the piston rod 7 and the pressure application member 3 connected to its front end move and stop.

The flow of current at the time of spot welding will be explained using FIG. 7. Current flows to the electrode tip 2 at the time of spot welding through the shank 1 as shown by the solid arrow. Due to this, the welding location of the metal sheets is heated and a nugget is formed.

The direction of the current (direction of arrow) is not particularly limited and may be opposite as well.

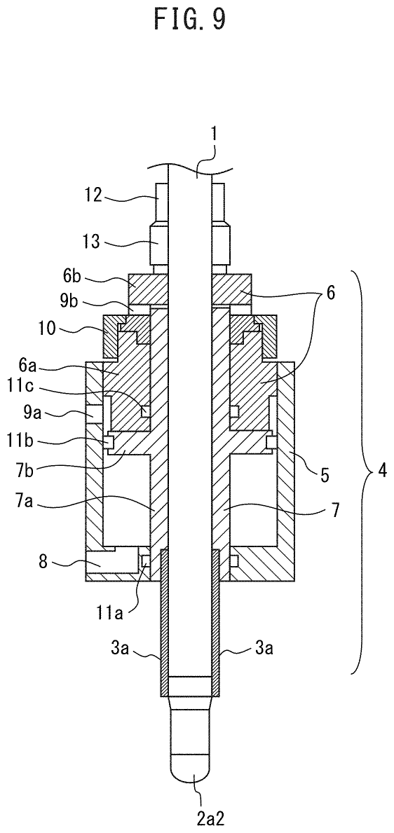

FIG. 9 is a cross-sectional schematic view when making the first pressure application member 3a of the welding apparatus of FIG. 8 move to the outside.

The first pressure application member 3a moves through the piston rod 7 by supplying and discharging compressed air through the port 8 and the ports 9a and 9b. As shown in FIG. 9, the piston rod 7 is made to move by compressed air and stops at a position limited by the inside cover 6a.

The material of the shank is not particularly limited so long as possible to hold an electrode tip and apply an electrode force from the electrode tip to the sheet combination, but for example it is possible to make it by a Cu—Cr alloy etc. and provide a cooling use pipe at the inside. The holder is not particularly limited so long as the shank 1 can be attached, but for example it is possible to make it by a Cu—Cr alloy etc. and provide a cooling use pipe at the inside.

### EXAMPLES

### Example 1

A 0.75 mm thick 270 MPa hot dip galvannealed steel sheet (thin sheet), a 1.6 mm thick 590 MPa hot dip galvannealed steel sheet (thick sheet), and a 2.3 mm thick 590 MPa hot dip galvannealed steel sheet (thick sheet) were overlaid to prepare a sheet combination with a total thickness of the metal sheets forming the sheet combination of 4.65 mm and a sheet thickness ratio of 6.2. The longitudinal and lateral dimensions of the steel sheet were 30 mm×100 mm.

As the first electrode tip and the second electrode tip, electrode tips of DR type front end 40R, front end diameter 6 mm, Cu-1% Cr alloy and diameter 13.0 mm were prepared. As the first pressure application member for arrangement around the first electrode tip, an inside diameter 13.2 mm, outside diameter 16.0 mm cylindrically shaped insulator (MC Nylon®) (engineering plastic) was prepared.

The first electrode tip and the second electrode tip were arranged facing each other across the sheet combination so that the first electrode tip was arranged at the thin sheet side and the second electrode tip was arranged at the opposite side of the sheet combination (thick sheet side).

The first pressure application member was arranged around the first electrode tip. The mean distance between the body part of the first electrode tip and the first pressure application member was 0.10 mm. Using springs, at the thin sheet side, the electrode force F2 of the first pressure application member was made 0.86 kN and the electrode force F1 of the first electrode tip was made 3.06 kN, while at the thick sheet side, only the second electrode tip was used and the electrode force F3 of the second electrode tip was made 3.92 kN. While applying the above electrode forces and changing the current value, spot welding was performed by a unit current conduction of 31 cyc (current run for 0.62 seconds). The inter-electrode distance between the first electrode tip and the second electrode tip when making the first electrode tip and the second electrode tip contact the sheet combination with a zero electrode force before welding was the total thickness of the metal sheets forming the sheet combination×1.1 or less. The obtained suitable current range was 3.0 kA. The above inter-electrode distance was obtained by measuring the distance between the front end of the first electrode tip and the front end of the second electrode tip when making the first electrode tip and the second electrode tip contact the sheet combination with a substantially zero electrode force before welding.

### Example 2

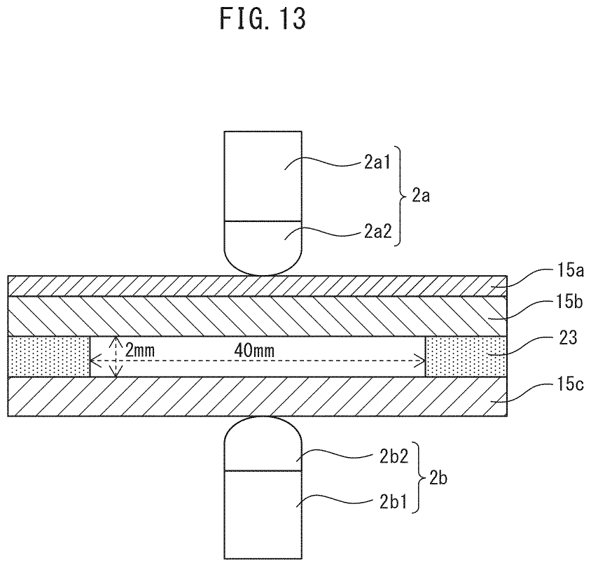

To evaluate more severe conditions, the inventors conducted an experiment under conditions simulating the case where there is a clearance between the thick sheet/thick sheet. Specifically, as shown in FIG. 13, they placed spacers at the two facing end parts between the thick sheet/thick sheet to pseudo form the state of presence of sheet clearance between the thick sheet/thick sheet. The thickness of the spacers was 2 mm, while the dimensions of the sheet clearance were a 40 mm span and height of 2 mm. Below, the case of placement of the spacers will be referred to as “spacers provided” while the case of no placement of spacers will be referred to as “no spacers provided”. Note that, in FIG. 13, illustration of the first pressure application member and the second pressure application member is omitted. As the second pressure application member for arrangement around the second electrode tip, an inside diameter 17.0 mm, outside diameter 20.0 mm cylindrically shaped Cu-1% Cr alloy was prepared.

Except for, in the above way, providing spacers and, further, arranging the second pressure application member around the second electrode tip to make the mean distance between the body part of the second electrode tip and the second pressure application member 2.00 mm and using springs to make the electrode force F2 of the first pressure application member 1.37 kN and the electrode force F1 of the first electrode tip 2.55 kN at the thin sheet side and to make the electrode force F4 of the second pressure application member 0.43 kN and the electrode force F3 of the second electrode tip 3.49 kN at the thick sheet side, spot welding was performed under the same conditions as Example 1. The inter-electrode distance between the first electrode tip and the second electrode tip when making the first electrode tip and the second electrode tip contact the sheet combination by zero electrode force before welding was over the total thickness of the metal sheets forming the sheet combination×1.1. When changing the current value while spot welding, a 1.5 kA suitable current range was obtained. In the following examples and comparative examples, in the case of no spacer provided, when the first electrode tip and the second electrode tip were made to contact the sheet combination with zero electrode force before welding, the relationship of (inter-electrode distance of first electrode tip and second electrode tip)≤(total thickness of metal sheets forming sheet combination×1.1) was satisfied, but in the case of spacers provided, the above relationship was not satisfied.

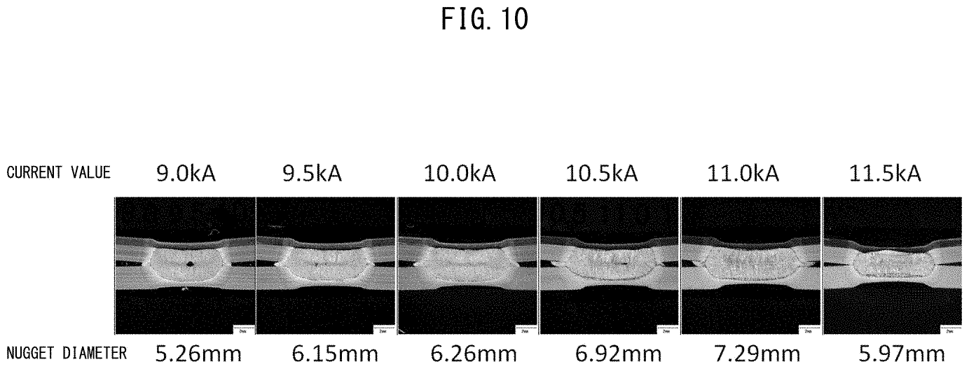

FIG. 10 shows a cross-sectional photograph of a sheet combination spot welded in Example 2. If the current value is 9.0 to 10.5 kA, the nugget diameter at the interface of the thin sheet/thick sheet was 5.26 to 6.92 mm. The reference nugget diameter is 4√t=4×√0.75=3.2 mm. A nugget diameter of the reference nugget diameter or more is obtained and no spatter occurred. If the current value is 11.0 to 11.5 kA, the nugget diameter at the interface of the thin sheet/thick sheet is 7.29 to 5.97 mm. A nugget diameter of the reference nugget diameter or more is obtained and spatter occurred. Therefore, a suitable current range of 1.5 kA of 9.0 to 10.5 kA was obtained.

### Example 3

Except for providing the spacers and, at the thin sheet side, making the electrode force F2 of the first pressure application member 1.37 kN and making the electrode force F1 of the first electrode tip 2.55 kN (total 3.92 kN), spot welding was performed under the same conditions as Example 1. The current value was changed while spot welding, whereby a 1.2 kA suitable current range was obtained.

### Comparative Example 1

Except for not using pressure application members for the thin sheet side and thick sheet side but using only the first electrode tip and the second electrode tip to make the electrode forces F1 and F3 respectively 3.92 kN, spot welding was performed under the same conditions as Example 1. The current value was changed while spot welding, whereby a 0.5 kA suitable current range was obtained.

### Comparative Example 2

Except for providing the spacers, spot welding was performed under conditions similar to Comparative Example 1. The current value was changed while spot welding, whereby the suitable current range was 0.0 kA.

Table 1 shows the provision of spacers in Examples 1 to 5 and Comparative Examples 1 to 2, the electrode forces F1, F2, F3, and F4, the mean distances between the electrodes and pressure application members, and the obtained suitable current ranges.

TABLE 1

| | | | | | | Mean distance | Mean distance | |
|---|---|---|---|---|---|---|---|---|
| | | | Pressure | | Pressure | between first | between second | |
| | | Pressure | force F2 of | Pressure | force F4 of | electrode and | electrode and | |
| | | force F1 of | first pressure | force F3 of | second pressure | first pressure | second pressure | Suitable |
| | | first electrode | application | second electrode | application | application | application | current |
| | Spacers | tip (kN) | member (kN) | tip (kN) | member (kN) | member (mm) | member (mm) | range (kA) |
| Example 1 | No spacers | 3.06 | 0.86 | 3.92 | — | 0.10 | — | 3.0 |
| | provided | | | | | | | |
| Example 2 | Spacers | 2.55 | 1.37 | 3.49 | 0.43 | 0.10 | 2.00 | 1.5 |
| | provided | | | | | | | |
| Example 3 | Spacers | 2.55 | 1.37 | 3.92 | — | 0.10 | — | 1.2 |
| | provided | | | | | | | |
| Comparative | No spacers | 3.92 | — | 3.92 | — | 0.10 | — | 0.5 |
| Example 1 | provided | | | | | | | |
| Comparative | Spacers | 3.92 | — | 3.92 | — | 0.10 | — | 0.0 |
| Example 2 | provided | | | | | | | |

### Examples 4 to 9

Except for using a first pressure application member having an inside diameter and outside diameter shown in Table 2 and cylindrical in shape, making the distance between the first electrode tip and the first pressure application member 0.10 mm, 0.25 mm, 0.40 mm, 0.60 mm, 0.90 mm, and 1.50 mm, and providing spacers in the same way as Example 2, spot welding was performed under the same conditions as Example 1. The suitable current ranges obtained in the examples are shown in Table 2.

TABLE 2

| | Inside diameter | Outside diameter | Distance between | |
|---|---|---|---|---|
| | of first pressure | of first pressure | first electrode tip | Suitable |
| | application | application | and first pressure | current |
| | member (mm) | member (mm) | application member | range (kA) |
| Example 4 | 13.2 | 16.0 | 0.10 | 2.1 |
| Example 5 | 13.5 | 16.3 | 0.25 | 2.0 |
| Example 6 | 13.8 | 16.6 | 0.40 | 1.9 |
| Example 7 | 14.2 | 17.0 | 0.60 | 1.8 |
| Example 8 | 14.8 | 17.6 | 0.90 | 1.6 |
| Example 9 | 16.0 | 18.8 | 1.50 | 1.5 |

### Examples 10 to 14

Except for using a second pressure application member having an inside diameter and outside diameter shown in Table 3 and cylindrical in shape and making the distance between the second electrode tip and the second pressure application member 0.10 mm, 0.25 mm, 0.40 mm, 0.60 mm, and 0.90 mm, spot welding was performed under the same conditions as Example 2. The suitable current ranges obtained in the examples are shown in Table 3.

TABLE 3

| | Inside diameter | Outside diameter | Distance between | |
|---|---|---|---|---|
| | of second pressure | of second pressure | second electrode tip | Suitable |
| | application | application | and second pressure | current |
| | member (mm) | member (mm) | application member | range (kA) |
| Example 10 | 13.2 | 16.0 | 0.10 | 2.5 |
| Example 11 | 13.5 | 16.3 | 0.25 | 2.4 |
| Example 12 | 13.8 | 16.6 | 0.40 | 2.3 |
| Example 13 | 14.2 | 17.0 | 0.60 | 2.1 |
| Example 14 | 14.8 | 17.6 | 0.90 | 2.0 |
| Example 2 | 13.2 | 16.0 | 2.00 | 1.5 |

### Comparative Examples 3 to 4

Except for using, instead of the first pressure application member, a third pressure application member having an inside diameter and outside diameter shown in Table 4, cylindrical in shape, and made of a Cu-1% Cr alloy and making the distance between the first electrode tip and third pressure application member 0.25 mm and 0.90 mm, spot welding was performed under the same conditions as Example 4. The suitable current ranges obtained in the examples are shown in Table 2.

TABLE 4

| | Inside diameter | Outside diameter | Distance between | |
|---|---|---|---|---|
| | of third pressure | of third pressure | first electrode tip | Suitable |
| | application | application | and third pressure | current |
| | member (mm) | member (mm) | application member | range (kA) |
| Comparative | 13.5 | 16.3 | 0.25 | 1.4 |
| Example 3 | | | | |
| Comparative | 14.8 | 17.6 | 0.90 | 1.0 |
| Example 4 | | | | |

### Comparative Examples 5 to 6

Except for using, instead of the second pressure application member, a fourth pressure application member having an inside diameter and outside diameter shown in Table 5, cylindrical in shape, and made of an insulator (MC Nylon®) (engineering plastic) and making the distance between the second electrode tip and fourth pressure application member 0.25 mm and 0.90 mm, spot welding was performed under the same conditions as Example 2. The suitable current ranges obtained in the examples are shown in Table 2.

TABLE 5

| | Inside diameter | Outside diameter | Distance between | |
|---|---|---|---|---|
| | of fourth pressure | of fourth pressure | second electrode tip | Suitable |
| | application | application | and fourth pressure | current |
| | member (mm) | member (mm) | application member | range (kA) |
| Comparative | 13.5 | 16.3 | 0.25 | 1.3 |
| Example 5 | | | | |
| Comparative | 14.8 | 17.6 | 0.90 | 0.9 |
| Example 6 | | | | |

### Comparative Examples 7 to 8

Except for using, instead of the first pressure application member, a third pressure application member having dimensions the same as the first pressure application member, cylindrical in shape, and made of a Cu-1% Cr alloy, using a second pressure application member having an inside diameter and outside diameter shown in Table 6 and cylindrical in shape, and making the distance between the second electrode tip and second pressure application member 0.25 mm and 0.90 mm, spot welding was performed under the same conditions as Example 2. The suitable current ranges obtained in the examples are shown in Table 2.

TABLE 6

| | Inside diameter | Outside diameter | Distance between | |
|---|---|---|---|---|
| | of second pressure | of second pressure | second electrode tip | Suitable |
| | application | application | and second pressure | current |
| | member (mm) | member (mm) | application member | range (kA) |
| Comparative | 13.5 | 16.3 | 0.25 | 0.6 |
| Example 7 | | | | |
| Comparative | 14.8 | 17.6 | 0.90 | 0.3 |
| Example 8 | | | | |

### Comparative Examples 9 to 10

Except for using, instead of the first pressure application member, a third pressure application member having dimensions the same as the first pressure application member, cylindrical in shape, and made of a Cu-1% Cr alloy, using instead of the second pressure application member, a fourth pressure application member having an inside diameter and outside diameter shown in Table 7, cylindrical in shape, and made of an insulator (MC Nylon®) (engineering plastic), and making the distance between the second electrode tip and fourth pressure application member 0.25 mm and 0.90 mm, spot welding was performed under the same conditions as Example 2. The suitable current ranges obtained in the examples are shown in Table 7.

TABLE 7

| | Inside diameter | Outside diameter | Distance between | |
|---|---|---|---|---|
| | of fourth pressure | of fourth pressure | second electrode tip | Suitable |
| | application | application | and fourth pressure | current |
| | member (mm) | member (mm) | application member | range (kA) |
| Comparative | 13.5 | 16.3 | 0.25 | 1.0 |
| Example 9 | | | | |
| Comparative | 14.8 | 17.6 | 0.90 | 0.6 |
| Example 10 | | | | |

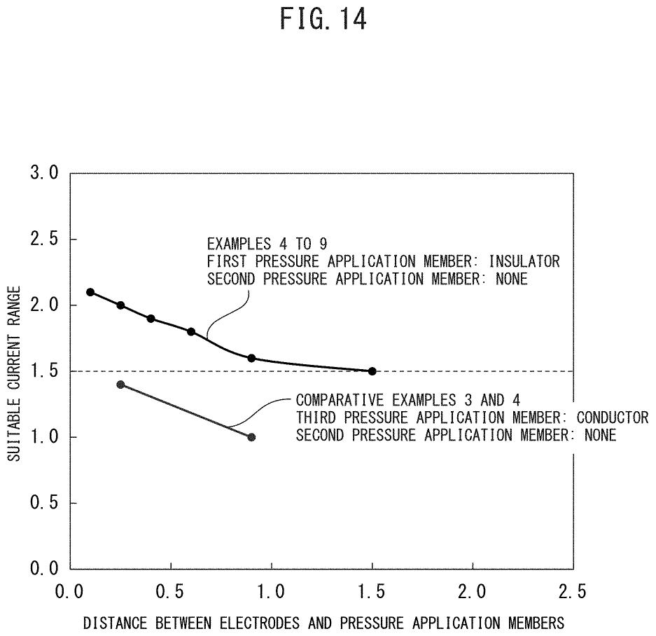

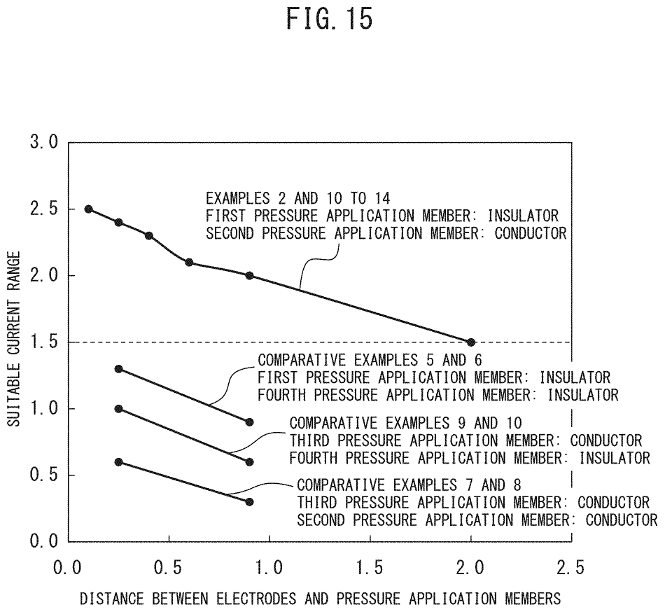

FIG. 14 shows a graph showing the relationships of the mean distances of the electrodes and pressure application members and suitable current ranges in Examples 4 to 9 and Comparative Examples 3 to 4. FIG. 15 shows a graph showing the relationships of the mean distances of the electrodes and pressure application members and suitable current ranges in Examples 2 and 10 to 14 and Comparative Examples 5 to 10.

### REFERENCE SIGNS LIST

1 shank
2a first electrode tip
2a1 body part of first electrode tip
2a2 front end part of first electrode tip
2b second electrode tip
2b1 body part of second electrode tip
2b2 front end part of second electrode tip
3a first pressure application member
3b second pressure application member
4 pneumatic cylinder
5 cylinder housing
6 rod cover
6a lower cover
6b upper cover
7 piston rod
7a rod part
7b ring part
8 port
9a, 9b port
10 bag nut
11a, 11b, 11c O-ring
12 screw adapter
13 nut
14 insulation sleeve
15a thinnest thickness metal sheet (thin sheet)
15b, 15c thick thickness metal sheet (thick sheet)
16 sheet combination
17 power supply
18 first drive mechanism
19 second drive mechanism
20 electrode force control part
21 molten metal
23 spacer
30 steel sheet member
31 flange
32 flange
33 spot welding part
D1 mean distance between body part of first electrode tip and first pressure application member
D2 mean distance between body part of second electrode tip and second pressure application member
F1 electrode force applied from first electrode tip to sheet combination
F2 electrode force applied from first pressure application member to sheet combination
F3 electrode force applied from second electrode tip to sheet combination
F4 electrode force applied from second pressure application member to sheet combination

1-5. (canceled)

6. A spot welding method for resistance spot welding a sheet assembly comprised of a plurality of metal sheets with a sheet thickness ratio of 5 or more which are overlaid, the spot welding method comprising
preparing a sheet assembly with a sheet thickness ratio of 5 or more having a metal sheet having a thinnest sheet thickness arranged at an outermost surface,
arranging a first electrode tip and a second electrode tip facing each other across the sheet assembly so that said first electrode tip is arranged at the side where said thinnest metal sheet is placed and so that said second electrode tip is arranged at the opposite side of said sheet assembly,
arranging a first pressure application member made of an insulator around the first electrode tip,
pressing front end parts of said first electrode tip and said first pressure application member and a front end part of said second electrode tip against said sheet assembly to apply electrode forces so that an electrode force applied from said first electrode tip to said sheet assembly becomes smaller than an electrode force applied from said second electrode tip to said sheet assembly, and
running current between said first electrode tip and said second electrode tip while pressing the front end parts of said first electrode tip and said first pressure application member and the front end part of said second electrode tip against said sheet assembly to apply electrode forces to thereby weld said sheet assembly.

7. The spot welding method according to claim 6, further comprising
arranging a second pressure application member made of a conductor around said second electrode tip,
pressing the front end parts of said first electrode tip and said first pressure application member and the front end part of said second electrode tip against said sheet assembly to apply electrode forces and making the front end part of said second pressure application member contact with said sheet assembly or press against said sheet assembly to apply an electrode force so that an electrode force applied from said first electrode tip to said sheet assembly becomes smaller than an electrode force applied from said second electrode tip to said sheet assembly, and
running current between said first electrode tip, and said second electrode tip and said second pressure application member while pressing the front end parts of said first electrode tip and said first pressure application member and the front end part of said second electrode tip against said sheet assembly to apply electrode forces and making the front end part of said second pressure application member contact with said sheet assembly or press against said sheet assembly to apply an electrode force to thereby weld said sheet assembly.

8. The spot welding method according to claim 6, wherein a mean distance between a body part of said first electrode tip and said first pressure application member is 0.5 mm or less.

9. The spot welding method according to claim 7, wherein a mean distance between a body part of said second electrode tip and said second pressure application member is 0.5 mm or less.

10. The spot welding method according to claim 7, wherein
when making said first electrode tip and said second electrode tip contact said sheet assembly with an electrode force of zero, if
(inter-electrode distance of first electrode tip and second electrode tip)≤(total thickness of metal sheets forming sheet assembly×1.1)
stands, an electrode force of said second pressure application member is lowered to 0.43 kN or less.

11. The spot welding method according to claim 7, wherein a mean distance between a body part of said first electrode tip and said first pressure application member is 0.5 mm or less.

12. The spot welding method according to claim 9, wherein
when making said first electrode tip and said second electrode tip contact said sheet assembly with an electrode force of zero, if
(inter-electrode distance of first electrode tip and second electrode tip)≤(total thickness of metal sheets forming sheet assembly×1.1)
stands, an electrode force of said second pressure application member is lowered to 0.43 kN or less.
